(19) United States
(12) Patent Application Publication
(10) Pub. No.: US 2021/0035559 A1
(43) Pub. Date: Feb. 4, 2021

(54) LIVE BROADCAST ROOM DISPLAY METHOD, APPARATUS AND DEVICE, AND STORAGE MEDIUM

(71) Applicant: GUANGZHOU HUYA INFORMATION TECHNOLOGY CO., LTD., Guangzhou, Guangdong (CN)

(72) Inventor: Zihao XU, Guangzhou (CN)

(21) Appl. No.: 16/976,230

(22) PCT Filed: May 27, 2019
(86) PCT No.: PCT/CN2019/088542

§ 371 Date: Aug. 27, 2020

(30) Foreign Application Priority Data
May 28, 2018 (CN) 201810520547.2

(51) Int. Cl. G10L 15/06; G10L 25/78; G10L 15/16; G10L 15/26

(52) U.S. Cl. CPC G10L 15/063; G10L 15/26; G10L 15/16; G10L 25/78

(57) ABSTRACT

Provided is a live broadcast room display method, apparatus and device, and a storage medium. The method includes: acquiring a speech signal within a set duration of at least one live broadcast room under a target classification label; inputting the speech signal within a set duration of the at least one live broadcast room into a speech detection model to obtain a speech signal that satisfies a set type condition; adding a display identifier to a live broadcast room corresponding to the speech signal that satisfies of live broadcast room; and arranging and displaying the at least one live broadcast room in a display interface corresponding to the target classification label according to the display identifier.

### CROSS-REFERENCES TO RELATED APPLICATIONS

This application claims priority to PCT Application No. PCT/CN2019/088542, filed on May 27, 2019 which is based upon and claims priority to Chinese Patent Application No. 201810520547.2, filed on May 28, 2018, the entire contents both of which are incorporated herein by reference.

### FIELD OF TECHNOLOGY

Embodiments of the present application relate to the field of Internet technologies and, for example, relate to a live broadcast room display method, apparatus and device, and a storage medium.

### BACKGROUND

With the rapid development of Internet technologies, the live streaming, as a new technology field, comes to the attention of the public. Users can watch the excellent performances of streamers in live broadcast rooms on their terminal devices.

The most common way to display live broadcast rooms is to arrange and display live broadcast rooms according to popularity values or the number of viewers. In the field of entertainment live broadcasting, singing by streamers is a popular performance form. However, since the time when the streamer sings is short, when a streamer starts singing, it is difficult for users to find live broadcast rooms in which the singing performance is in progress among a large number of live broadcast rooms in time.

### SUMMARY

An aspect relates to a live broadcast room display method, apparatus and device, and a storage medium, so as to display live broadcast rooms in which a performance is in progress to a user in a timely and effective manner such that the user can timely find the live broadcast rooms in which a performance is currently in progress. Therefore, the operation of the user is simplified, attracting the user is attracted to watch, and the average online viewing time of the user is increased.

In a first aspect, the embodiments of the present application provide a live broadcast room display method. The method includes the steps described below.

A speech signal within a set duration of at least one live broadcast room under a target classification label is acquired.

The speech signal within a set duration of the at least one live broadcast room is input into a speech detection model to obtain a speech signal that satisfies a set type condition.

A display identifier is added to a live broadcast room corresponding to the speech signal of the set type condition.

The at least one live broadcast room is arranged and displayed in a display interface corresponding to the target classification label according to the display identifier.

In a second aspect, the embodiments of the present application provide a live broadcast room display apparatus. The apparatus includes a speech acquiring module, a signal inputting module, an identifier adding module and an arranging and displaying module.

The speech acquiring module is configured to acquire a speech signal within a set duration of at least one live broadcast room under a target classification label.

The signal inputting module is configured to input the speech signal within a set duration of the at least one live broadcast room into a speech detection model to obtain a speech signal that satisfies a set type condition.

The identifier adding module is configured to add a display identifier to a live broadcast room corresponding to the speech signal of the set type condition.

The arranging and displaying module is configured to arrange and display the at least one live broadcast room in a display interface corresponding to the target classification label according to the display identifier.

In a third aspect, the embodiments of the present application further provide a computer device. The computer device includes one or more processors.

The computer device also includes a storage medium, which is configured to store one or more programs.

When executed by the one or more processors, the one or more programs enable the one or more processors to implement the live broadcast room display method of any one of the embodiments of the present application.

In a fourth aspect, the embodiments of the present application further provide a computer-readable storage medium having a computer program stored thereon that, upon execution by a processor, implements the live broadcast room display method of any one of embodiments of the present application.

### BRIEF DESCRIPTION

Some of the embodiments will be described in detail, with reference to the following figures, wherein like designations denote like members, wherein:

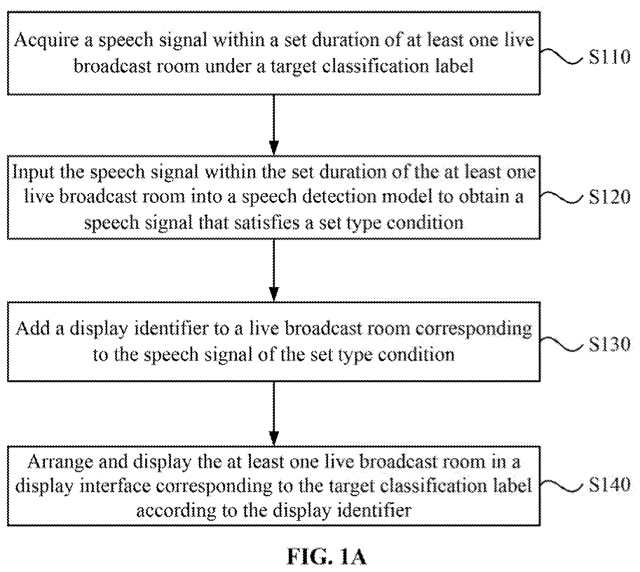

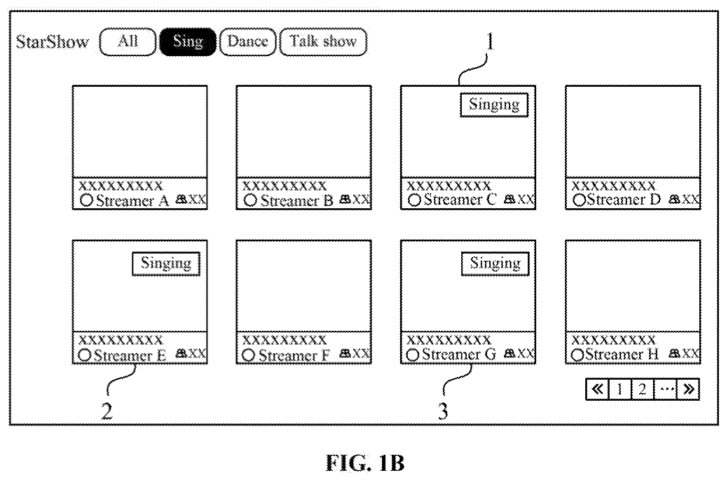

FIG. 1A is a flowchart of a live broadcast room display method according to an embodiment one of the present application;

FIG. 1B is a schematic view showing a live broadcast room display interface suitable to the embodiment one of the present application;

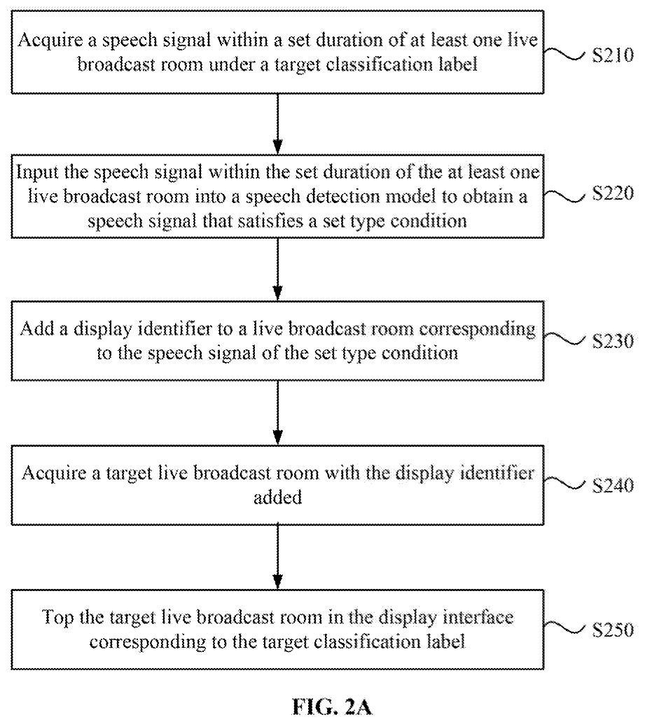

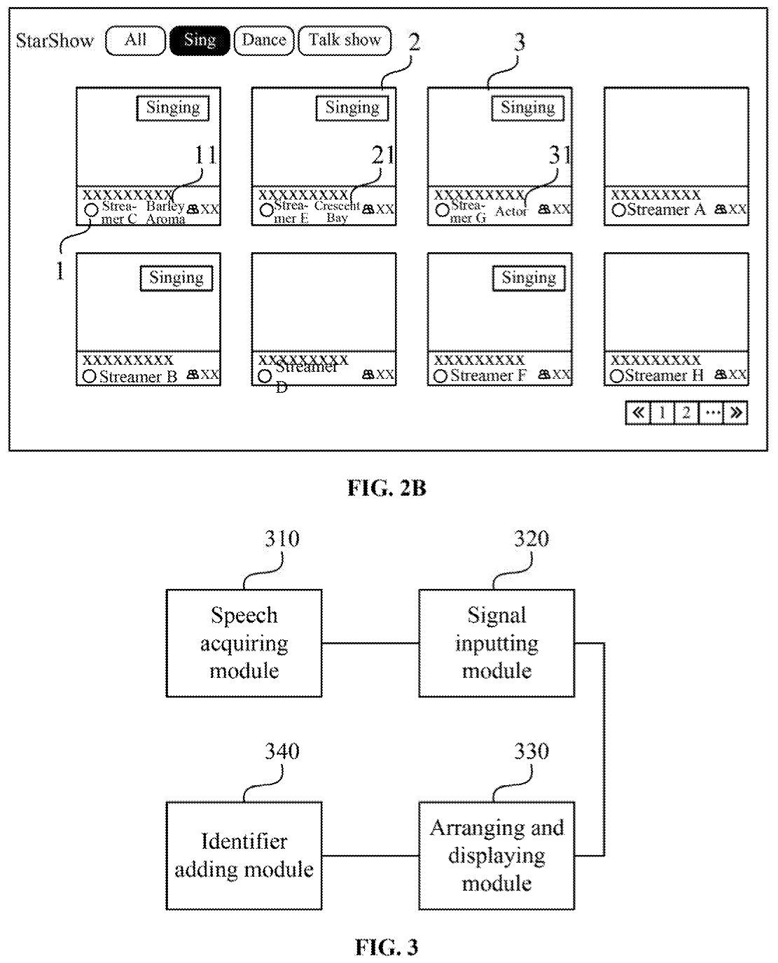

FIG. 2A is a flowchart of a live broadcast room display method according to an embodiment two of the present application;

FIG. 2B is a schematic view showing a live broadcast room display interface suitable to the embodiment two of the present application;

FIG. 3 is a structural diagram of a live broadcast room display apparatus according to an embodiment three of the present application; and

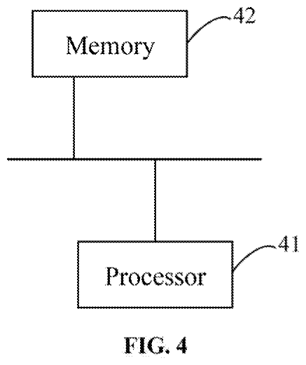

FIG. 4 is a structural diagram of a computer device according to an embodiment four of the present application.

### DETAILED DESCRIPTION

The present application will be described below in conjunction with drawings and embodiments. It is to be understood that the embodiments set forth below are intended to illustrate and not to limit the present application. It is to be noted that to facilitate description, only part, not all, of structures related to the present application are illustrated in the drawings.

### Embodiment One

FIG. 1A is a flowchart of a live broadcast room display method according to an embodiment one of the present application. The method is applicable to a case where live broadcast rooms on an online live broadcast platform are arranged and displayed. The method can be executed by a live broadcast room display apparatus, which can be composed of hardware and/or software and is generally integrated into a server and all terminals capable of providing an online live broadcast function. This embodiment is illustrated with the server as an executing subject. The method provided by this embodiment includes the steps describe below.

In S110, a speech signal within a set duration of at least one live broadcast room under a target classification label is acquired.

In this embodiment, the live broadcast room may be an online live broadcast room in which the performance is in progress and which is provided by an online live broadcast platform. The classification label is a label attached to the live broadcast room on the online live broadcast platform according to a type of the live broadcast room. The live broadcast rooms are displayed in a classification manner according to the classification labels to which the live broadcast rooms belong. In one embodiment, the target classification label may be a live broadcast room for a particular language performance, such as a singing type live broadcast room. In one embodiment, the online live broadcast platform may include a server and multiple terminals. In one embodiment, the streamer can log in a streamer account on a terminal used by himself and establish a live broadcast room or enter a live broadcast room associated with the streamer account, so as to perform live broadcasting, and at the same time, a user can also enter the live broadcast room by logging in a user account on his terminal and watch live broadcast content of the streamer.

Exemplarily, a speech signal of at least one live broadcast room under the target classification label may be acquired at preset frequency intervals. For example, 5 seconds of speech signals are respectively acquired every 10 seconds from multiple singing type live broadcast rooms in which the live broadcasting is in progress on the online live broadcast platform. The speech signal may be a sound signal collected by a streamer microphone in a live broadcast room.

In the online live broadcasting, since the content of the current performance of the streamer is different, the acquired speech signals also have differences. For example, if the streamer is singing, the speech content of the speech signals will show song characteristics or lyric characteristics, which has a certain difference from the speech signals acquired when the streamer is not singing, so that the speech signals can be recognized through the difference.

Taking the case where the streamer is singing as an example, an audio waveform included in the acquired speech signal may show regularity, i.e., characteristics of a song, or the speak content recognized from the speech signal is consistent with the lyrics in the song, i.e., characteristics of the lyrics. When the streamer is not singing, the audio waveform included in the acquired speech signal has no regularity, and a song with lyrics consistent with the speak content recognized from the speech signal cannot be found.

In S120, the speech signal within a set duration of the at least one live broadcast room is input into a speech detection model to obtain a speech signal that satisfies a set type condition.

In this embodiment, the speech detection model is configured to recognize the input speech signal, so that the speech signal that satisfies the set type condition is recognized. In one embodiment, the set type condition may include a singing condition. In one embodiment, the speech detection model may be a model trained according to a preset deep learning algorithm. Exemplarily, by inputting the acquired speech signal into the speech detection model, a speech signal meeting the singing condition can be screened out, that is, the live broadcast room in which the singing performance is in progress can be recognized from multiple singing type live broadcast rooms through the speech detection model.

In one embodiment, the speech detection model is obtained by training a set deep learning model using singing type speech signal samples and non-singing type speech signal samples.

In one embodiment, the operation principle of the speech detection model may be that when a speech signal is input, the speech detection model performs speech recognition on the input speech signal, analyzes recognized speech information, determines whether the speech information included in the input speech signal complies with the set type condition, and if the speech information included in the input speech signal complies with the set type condition, outputs the speech signal, otherwise, discards the speech signal. For example, a speech signal acquired from a live broadcast room in which a streamer is singing currently is input into the speech detection model, and after the speech detection model performs speech recognition and speech analysis on the speech signal, the speech detection model determines that the speech signal complies with the singing condition, and outputs the speech signal.

The purpose of inputting the speech signal into the speech detection model in this embodiment is to determine whether a performance is in progress in the live broadcast room according to the acquired speech signal, and screen out the live broadcast room in which the performance is in progress so as to mark a display identifier on the live broadcast room in which the performance is in progress, and distinctively display this live broadcast room from other live broadcast rooms which are live but has no performance in progress. In such way, it helps the user to rapidly find the live broadcast room in which the wonderful performance is in progress.

In one embodiment, before the speech signal within a set duration of the at least one live broadcast room is input into the speech detection model to obtain the speech signal that satisfies the set type condition, the method further includes the following steps: respectively obtaining singing type speech signal samples and non-singing type speech signal samples; and training a set deep learning model using the speech signal samples to obtain the speech detection model.

In one embodiment, the speech signal samples may be extracted from multiple live videos in the online live broadcast platform, or may be downloaded from the Internet through a specific search engine, which is not limited herein. Taking a case of extracting the speech signal samples from multiple live videos in the online live broadcast platform as an example, multiple live broadcast rooms under multiple classification labels are searched for from a target online live broadcast platform, then multiple speech signals are extracted from the multiple live broadcast rooms respectively, and a singing type or non-singing type label is marked on the multiple extracted speech signals so as to obtain the speech signal samples. In this embodiment, the classification labels include, but are not limited to, singing type, food class, competitive game class, traveling class, beauty and make-up class, and the like. In one embodiment, specifically, the acquired speech signal samples may be classified in a manual evaluation classification manner, that is, in a manual manner, the speech signals which are acquired from multiple live broadcast rooms and which contain singing performances are labeled with singing type labels as singing type speech signal samples, and other speech signals which do not contain singing performances are labeled with non-singing type labels as non-singing type speech signal samples.

In this embodiment, the set deep learning model may be a training model established based on an artificial neural network algorithm, such as recurrent neural Network (RNN). RNN is an artificial neural network where nodes are connected to form a ring in an oriented manner, and the internal state of this kind of networks can display dynamic temporal action. Different from the feedforward neural network, RNN may use internal memory to process input sequences in any time sequence, which makes it easier for RNN to handle handwriting recognition, speech recognition and so on. The training process of the deep learning model can be the process of adjusting neural network parameters. The optimal neural network parameters can be obtained through continuous training, and the set deep learning model having the optimal neural network parameters is the final model to be obtained. Exemplarily, after multiple speech signal samples are obtained, the set deep learning model is trained by using multiple speech signal samples, and the neural network parameters in the set deep learning model are constantly adjusted such that the set deep learning model gets the ability to recognize the input speech signal, so that the speech detection model is obtained.

In one embodiment, the step of respectively obtaining singing type speech signal samples and non-singing type speech signal samples includes: calling a search engine interface to search for and download multiple audio files matched with set keywords corresponding to the singing type and the non-singing type respectively; randomly extracting a set number of audio files from multiple singing type audio files as singing type speech signal samples; and randomly extracting a set number of audio files from multiple non-singing type audio files as non-singing type speech signal samples.

Exemplarily, the set keyword corresponding to the singing type may be a keyword through which a download address of a singing type audio file can be searched for by using a specific search engine, such as a song name or a song library name; the set keyword corresponding to the non-singing type may be a keyword through which a download address of a non-singing type audio file is searched for by using a specific search engine. For example, one of the singing type audio files may be an audio file having an audio format such as .mp3 or .mp4, which is searched for according to the song name “Little Rabbit”; one of the non-singing type audio files may be an audio file having an audio format such as .mp3 or .mp4, which is searched for according to the keyword “Talk Show”.

In one embodiment, after the download address is acquired, the download address is directly accessed and audio files in multiple resources are downloaded and stored in a samples library address of the corresponding type. When the set deep learning model needs to be trained, a set number of audio files are extracted from the singing type audio files in the samples library as singing type speech signal samples, and a set number of audio files are extracted from the non-singing type audio files in the samples library as non-singing type speech signal samples. Of course, a set number of audio files may be extracted from the singing type audio files, and some audio segments are intercepted from the extracted audio files as singing type speech signal samples. This method may also be specifically used to acquire the non-singing type speech signal samples, which is not repeated herein.

In S130, a display identifier is added to a live broadcast room corresponding to the speech signal of the set type condition.

Exemplarily, each live broadcast room may be manually marked with a classification label by a streamer or a platform staff when the live broadcasting starts, live broadcast rooms marked with the same classification label are displayed in a display interface corresponding to the classification label, and display interfaces corresponding to multiple classification labels may be on a terminal used by the user. In the live broadcast process, the display identifier can be dynamically added to the live broadcast room according to whether a performance is in progress in multiple live broadcast rooms under the target classification label, that is, live broadcast rooms in which a performance is being currently performed are distinguished by using the display identifier. In this embodiment, the display identifier may be an identifier specific to the live broadcast room in which the performance is currently in progress in all live broadcast rooms displayed under the target classification label. For example, the display identifier may be a segment of text mark or a pattern mark. For example, when the set type condition is the singing condition, a speech signal that complies with the singing condition is screened out by using the speech detection model, and a display identifier “Singing” is added to a live broadcast room corresponding to the speech signal (i.e., the live broadcast room in which a singing performance is currently in progress). When the speech detection is performed again, if the speech signal acquired from the live broadcast room labeled with the display identifier “Singing” does not comply with the singing condition, that is, the streamer in this live broadcast room has finished his singing performance, this display identifier added on the live broadcast room is removed.

In the embodiments of the present application, the display identifier may be added to live broadcast rooms corresponding to all speech signals of the set type condition, or the display identifier may be added to live broadcast rooms corresponding to part of speech signals of the set type condition according to actual requirements.

Since singing performed by the streamer is a kind of performance form popular to the users, in the singing type live broadcast room display interface, live broadcast rooms in which the singing performance is being currently performed and other singing type live broadcast rooms are labeled separately, so that the user can timely find the live broadcast rooms in which the singing performance is currently in progress, thereby attracting the user to watch, and on the other hand, improving the performance enthusiasm of the streamer, especially the singing enthusiasm.

In S140, the at least one live broadcast room is arranged and displayed in a display interface corresponding to the target classification label according to the display identifier.

Exemplarily, multiple classification tabs may be displayed on the interface of the terminal used by the user, where each classification tab corresponds to a different classification label, and at least one live broadcast room under the classification label is displayed in the display interface corresponding to each classification tab, and when a live broadcast room with a display identifier added is included under the target classification label, live broadcast rooms with the display identifier added are displayed distinctively from other live broadcast rooms without any display identifier added. In one embodiment, the user can view all live broadcast rooms in which the live broadcasting is in progress under the target classification label by clicking a classification tab on the interface. Among these live broadcast rooms, live broadcast rooms with the display identifier are live broadcast rooms in which a performance is in progress, and other live broadcast rooms without display identifier are live broadcast rooms in which a performance is not in progress, thereby realizing timely and effective display of live broadcast rooms in which a performance is in progress to the user, and making it easy for the user to timely and effectively find live broadcast rooms in which a performance is in progress.

For example, the latest 5 seconds of speech signals are acquired from the multiple singing type live broadcast rooms respectively and input to the speech detection model one by one. If a speech signal that complies with the singing condition is obtained, a display identifier is added to the live broadcast room to which the speech signal belongs. In the interface of the terminal used by the user, as shown in FIG. 1B, the related information of multiple singing type live broadcast rooms is displayed in the display interface corresponding to the “Sing” label, for example, a live broadcast interface thumbnail or a corresponding preset cover of this live broadcast room is displayed. “Singing” is displayed on pictures corresponding to singing type live broadcast rooms with the display identifier added in the display interface (such as the first live broadcast room 1, the second live broadcast room 2 and the third live broadcast room 3) such that these live broadcast rooms can be displayed distinctively from other singing type live broadcast rooms without any display identifier added.

In the technical solution of this embodiment, a speech signal acquired from at least one live broadcast room under a target classification label is input into a trained speech detection model to obtain a speech signal that satisfies a set type condition, a display identifier is added to a live broadcast room corresponding to the speech signal that satisfies the set type condition, and the at least one live broadcast room is arranged and displayed in a display interface corresponding to the target classification label according to the display identifier. By adding a display identifier to a live broadcast room according to live broadcast content in real time, live broadcast rooms in which a performance is in progress is displayed to a user in a timely and effective manner such that the user can timely find the live broadcast rooms in which a performance is currently in progress, thereby simplifying the operation of the user, attracting the user to watch, and improving average online viewing time of the user.

### Embodiment Two

FIG. 2A is a flowchart of a live broadcast room display method according to an embodiment two of the present application. This embodiment is illustrated on the basis of the above embodiments, and provides a live broadcast room display method. This embodiment describes that at least one live broadcast room is arranged and displayed in a display interface corresponding to the target classification tag according to the display identifier. The method provided by this embodiment includes the steps describe below.

In S210, a speech signal within a set duration of at least one live broadcast room under a target classification label is acquired.

In S220, the speech signal within a set duration of the at least one live broadcast room is input into a speech detection model to obtain a speech signal that satisfies a set type condition.

In S230, a display identifier is added to a live broadcast room corresponding to the speech signal of the set type condition.

In S240, a target live broadcast room with the display identifier added is acquired.

In this embodiment, the target live broadcast room with the display identifier added is a live broadcast room corresponding to all speech signals that satisfies the set type condition. For example, the target live broadcast room in singing type live broadcast rooms is a live broadcast room in which a singing performance is being currently performed. The display identifier may be an identifier specific to the live broadcast room in which the performance is currently in progress in all live broadcast rooms displayed under the target classification label. For example, the display identifier may be a segment of text mark or a pattern mark. For example, all live broadcast rooms marked with “Singing” are acquired from singing type live broadcast rooms as target live broadcast rooms.

In S250, the target live broadcast room is topped in the display interface corresponding to the target classification label.

Exemplarily, if a live broadcast room with a display identifier added, i.e., the target live broadcast room, is contained under the target classification label, the live broadcast room with the display identifier added is topped in the display interface corresponding to the target classification label, that is, the live broadcast room with the display identifier added is arranged before other live broadcast rooms with no display identifier added. In one embodiment, when the number of target live broadcast rooms is multiple, the multiple target live broadcast rooms may be arranged in a preset arranging manner and then displayed, where the preset arranging manner includes, but is not limited to, an arranging manner in accordance to the number of current users in the target live broadcast room or an arranging manner in accordance to performance scores.

Topping the target live broadcast room for display may have the following advantages: the live broadcast room in which a performance is being currently performed can be displayed at a more prominent position, which is compatible with the observation habit of human beings from top to bottom, such that the user can conveniently and quickly find the live broadcast room in which the performance is in progress, and the user is attracted to watch; and on the other hand, in order to enable his live broadcast room at a position which is easy to be found, the streamer may improve the performance frequency, thereby improving the performance enthusiasm of the streamer.

For example, as shown in FIG. 2B, in the interface of the user terminal, the related information of multiple singing type live broadcast rooms is displayed in the display interface corresponding to the “Sing” label, such as a live broadcast interface thumbnail (or a corresponding preset cover) of the live broadcast room, information on the streamer of the live broadcast room (such as nicknames and profile photos), individuality signature of the streamer, the number of users in the current live broadcast room and the like, and the live broadcast rooms labeled with the “Singing” is displayed on top, so as to be arranged and displayed in front of other live broadcast rooms without “Singing” labeled.

In one embodiment, the step of topping the target live broadcast room in the display interface corresponding to the target classification label includes the following steps: acquiring a current speech signal of the target live broadcast room in real time and acquiring matched song content according to the current speech signal; scoring the target live broadcast room according to a matching degree between the current speech signal and an audio feature of the song content; and arranging the target broadcast room according to the score, and topping the arranged target broadcast room in the display interface corresponding to the target classification label.

In one embodiment, the song content may be a singing type audio file which matches the speech signal and which is searched for from the samples library, or may be a singing type audio file which matches the speech signal and may be searched for from a preset music library, which is not limited herein. In one embodiment, the manner of matching includes, but is not limited to, that the audio file includes a content segment that is the same as or similar to the corresponding acquired speech signal of the target live broadcast room. In one embodiment, the similarity may be represented by similarity in the recognized audio features, and may also be represented by similarity in the recognized lyrics. In one embodiment, the audio features may include pitch, timbre, intensity and the like. Taking a case where the recognized lyrics are similar as an example, if “smile and recall the dreams in childhood” is recognized from the speech signal corresponding to the target live broadcast room, an audio file “Barley Aroma .mp3” containing the lyrics of the sentence is obtained from the preset music library.

Beneficial effects of adding a scoring mechanism to the target live broadcast room in this embodiment may be that importance attached to the singing quality by the streamer can be improved, and the viewing experience of the user can be improved, thereby attracting more users to watch the streamer.

In one embodiment, the current speech signal of the singing type live broadcast room, i.e., the current speech signal of the target live broadcast room, can be acquired in real time, audio analysis is performed on the speech signal, and the singing performance performed by the streamer in this live broadcast room is scored according to the audio feature of the song content that matches the current speech signal and the audio similarity of the speech signal, i.e., the matching degree. The higher the matching degree is, the higher the corresponding score is. Exemplarily, the scoring frequency may be evaluated according to the frequency of each sentence of the lyrics, or may be evaluated at intervals of a preset time, which is not limited herein. After a song is finished, the total score or average score of multiple scores in the song may be calculated as the score of the song.

Finally, in the display interface corresponding to the target classification label, i.e., the display interface corresponding to the singing type label shown in FIG. 2B, all live broadcast rooms marked with “Singing” are arranged according to the score and then displayed. In one embodiment, live broadcast rooms are arranged according to real-time scores for display, or may be arranged according to scores of each song, which is not limited herein. In one embodiment, the scores of the target live broadcast rooms can be displayed sequentially according to the scores in a descending order. For example, as shown in FIG. 2B, the live broadcast rooms marked “Singing” are the first live broadcast room 1, the second live broadcast room 2, and the third broadcast live room 3. Since the first broadcast live room 1 is rated 96 points, the second live broadcast room 2 is rated 92 points, and the third live broadcast room 3 is rated 80 points, the first live broadcast room 1 is displayed in a first position, the second live broadcast room 2 is displayed in a second position, the third live broadcast room 3 is displayed in a third position, and the first live broadcast room 1, the second live broadcast room 2 and the third live broadcast room 3 are displayed at the top.

In one embodiment, after the current speech signal of the target live broadcast room in real time is acquired and the matched song content is acquired according to the current speech signal, the following step is further included: a song name corresponding to the song content is displayed in an information display area corresponding to the target live broadcast room in the display interface corresponding to the target classification label.

In this embodiment, the information display area corresponding to the target live broadcast room may be set in a position area close to the image, such as below, above, on the left side of, or on the right side of the image of the target live broadcast room, which is not limited herein. The advantage of displaying the song name corresponding to the song content is that the user can know the name of the song that the streamer is singing in the live broadcast room without clicking and then entering the live broadcast room, such that it is convenient for the user to choose enter the live broadcast room in which the singing performance is in progress or not according to his tastes and interest, and the user does not need to click many times and enter different live broadcast rooms to look for the song that he liked to listen, thereby reducing the user operation.

For example, as shown in FIG. 2B, a singing performance is currently performed in the first live broadcast room 1 and the song name corresponding to the matched song content is “Barley Aroma”, so the song name “Barley Aroma” is displayed in the information display area 11 corresponding to the first live broadcast room 1. Similarly, the song name “Crescent Bay” is displayed in the information display area 21 corresponding to the second live broadcast room 2, and the song name “Actor” is displayed in the information display area 31 corresponding to the third live broadcast room 3.

In the technical solution of this embodiment, the target live broadcast room with the display identifier added is topped in the display interface corresponding to the target classification label for display such that the live broadcast room in which the performance is currently in progress can be displayed in a more conspicuous position. Therefore, the user can conveniently and quickly find the live broadcast room in which the performance is in progress, and the user is attracted to watch; and on the other hand, in order to enable his live broadcast room at a position which is easy to be found, the streamer may improve the performance frequency, thereby improving the performance enthusiasm of the streamer.

### Embodiment Three

FIG. 3 is a structural diagram of a live broadcast room display apparatus according to an embodiment three of the present application. With reference to FIG. 3, the live broadcast room display apparatus includes a speech acquiring module 310, a signal inputting module 320, an identifier adding module 330 and an arranging and displaying module 340. The various modules are described below.

The speech acquiring module 310 is configured to acquire a speech signal within a set duration of at least one live broadcast room under a target classification label.

The signal inputting module 320 is configured to input the speech signal within a set duration of the at least one live broadcast room into a speech detection model to obtain a speech signal that satisfies a set type condition.

The identifier adding module 330 is configured to add a display identifier to a live broadcast room corresponding to the speech signal of the set type condition.

The arranging and displaying module 340 is configured to arrange and display the at least one live broadcast room in a display interface corresponding to the target classification label according to the display identifier.

In the live broadcast room display apparatus provided by this embodiment, through the speech acquiring module 310, the signal inputting module 320, the identifier adding module 330 and the arranging and displaying module 340, a speech signal acquired from at least one live broadcast room under a target classification label is input into a trained speech detection model to obtain a speech signal that satisfies a set type condition, a display identifier is added to a live broadcast room corresponding to the speech signal that satisfies the set type condition, and the at least one live broadcast room is arranged and displayed in a display interface corresponding to the target classification label according to the display identifier. By adding a display identifier to a live broadcast room according to live broadcast content in real time, live broadcast rooms in which a performance is in progress is displayed to a user in a timely and effective manner such that the user can timely find the live broadcast rooms in which a performance is currently in progress, thereby simplifying the operation of the user, attracting the user to watch, and improving average online viewing time of the user.

In one embodiment, the set type condition may include a singing condition.

In one embodiment, the speech detection model is obtained by training a set deep learning model using a singing type speech signal samples and non-singing type speech signal samples.

In one embodiment, the live broadcast room display apparatus may further include a samples acquiring module and a model training module.

The samples acquiring module is configured to respectively obtain singing type speech signal samples and non-singing type speech signal samples before the speech signal within a set duration of the at least one live broadcast room is input into the speech detection model to obtain the speech signal that satisfies the set type condition.

The model training module is configured to train a set deep learning model using the singing type speech signal samples and the non-singing type speech signal samples to obtain the speech detection model.

In one embodiment, the samples acquiring module is configured to call a search engine interface to search for and download multiple audio files matched with set keywords corresponding to the singing type and the non-singing type respectively; randomly extract a set number of audio files from multiple singing type audio files as singing type speech signal samples; and randomly extract a set number of audio files from multiple non-singing type audio files as non-singing type speech signal samples.

In one embodiment, the arranging and displaying module 340 may include a target acquiring sub-module and a topping display sub-module.

The target acquiring sub-module is configured to acquire a target live broadcast room with the display identifier added.

The topping display sub-module is configured to top the target live broadcast room in the display interface corresponding to the target classification label for display.

In one embodiment, the topping display sub-module is configured to: acquire a current speech signal of the target live broadcast room in real time and acquire matched song content according to the current speech signal; score the target live broadcast room according to a matching degree between the current speech signal and an audio feature of the song content; and arrange the target broadcast room according to the score, and top the arranged target broadcast room in the display interface corresponding to the target classification label.

In one embodiment, the topping display sub-module is further specifically configured to display a song name corresponding to the song content in an information display area corresponding to the target live broadcast room in the display interface corresponding to the target classification label after the current speech signal of the target live broadcast room in real time is acquired and the matched song content is acquired according to the current speech signal.

The above products can execute the method provided by any embodiment of the present application, and has functional modules and beneficial effects corresponding to the execution method.

### Embodiment Four

FIG. 4 is a structural diagram of a computer device according to an embodiment four of the present application. As shown in FIG. 4, the computer device provided by this embodiment includes a processor 41 and a memory 42. The number of processors in the computer device may be one or more, and one processor 41 is used as an example in FIG. 4 for illustration. The processor 41 and the memory 42 in the computer device may also be connected via a bus or in other manners, and connecting via a bus is used as an example in FIG. 4 for illustration.

The processor 41 of the computer device in this embodiment integrates the live broadcast room display apparatus provided in the embodiments described above. In addition, as a computer-readable storage medium, the memory 42 in the computer device can be configured to store one or more programs. The programs may be software programs, computer-executable programs and modules thereof, such as program instructions/modules corresponding to the live broadcast room display method in the embodiments of the present invention (e.g., modules in the live broadcast room display apparatus shown in FIG. 3, which includes the speech acquiring module 310, the signal inputting module 320, the identifier adding module 330 and the arranging and displaying module 340). The processor 41 operates the software programs, instructions or modules stored in the memory 42 to execute function applications and data processing, that is, to implement the live broadcast room display method in the above method embodiments.

The memory 42 may include a program storage region and a data storage region. The program storage region may store an operating system and an application program required by at least one function; and the data storage region may store data created depending on use of a device. Furthermore, the memory 42 may include a high speed random access memory, and may also include a nonvolatile memory such as at least one disk memory, flash memory or another nonvolatile solid state memory. In some examples, the memory 42 may include memories which are remotely disposed relative to the processor 41 and these remote memories may be connected to the device via a network. Examples of the above network include, but are not limited to, the Internet, an intranet, a local area network, a mobile communication network and a combination thereof.

When executed by the one or more processors 41, the one or more programs included in the above computer device execute following operations.

A speech signal within a set duration of at least one live broadcast room under a target classification label is acquired; the speech signal within a set duration of the at least one live broadcast room is input into a speech detection model to obtain a speech signal that satisfies a set type condition; a display identifier is added to a live broadcast room corresponding to the speech signal that satisfies of live broadcast room; and the at least one live broadcast room is arranged and displayed in a display interface corresponding to the target classification label according to the display identifier.

### Embodiment Five

The embodiment five of the present application further provides a computer-readable storage medium having a computer program stored thereon that, upon execution by the live broadcast room display apparatus, implements the live broadcast room display method provided by the embodiment one of the present application. The method includes: acquiring a speech signal within a set duration of at least one live broadcast room under a target classification label; inputting the speech signal within a set duration of the at least one live broadcast room into a speech detection model to obtain a speech signal that satisfies a set type condition; adding a display identifier to a live broadcast room corresponding to the speech signal that satisfies of live broadcast room; and arranging and displaying the at least one live broadcast room in a display interface corresponding to the target classification label according to the display identifier.

Of course, in the computer-readable storage medium provided by this embodiment of the present application, the computer program stored thereon implements not only the above method operations but also related operations in the live broadcast room display method provided by any embodiment of the present application.

From the above description of embodiments, it will be apparent to those skilled in the art that the present application may be implemented by software and general-purpose hardware, or may of course be implemented by hardware. Based on this understanding, the technical solutions provided by the present application may be embodied in the form of a software product. The software product is stored in a computer-readable storage medium, such as a computer floppy disk, a read-only memory (ROM), a random access memory (RAM), a flash, a hard disk or an optical disk, and includes several instructions for enabling a computer device (which may be a personal computer, a server or a network device) to execute the method of any embodiment of the present application.

Various nits and modules included in the embodiment of the live broadcast room display apparatus are just divided according to functional logic, and the division is not limited to this, as long as the corresponding functions can be realized. In addition, the name of the each functional unit is just intended for distinguishing, and is not to limit the protection scope of the embodiments of the present application.

Although the present invention has been disclosed in the form of preferred embodiments and variations thereon, it will be understood that numerous additional modifications and variations could be made thereto without departing from the scope of the invention.

For the sake of clarity, it is to be understood that the use of ‘a’ or ‘an’ throughout this application does not exclude a plurality, and ‘comprising’ does not exclude other steps or elements.

1. A live broadcast room display method, comprising:
acquiring a speech signal within a set duration of at least one live broadcast room under a target classification label;
inputting the speech signal within a set duration of the at least one live broadcast room into a speech detection model to obtain a speech signal that satisfies a set type condition;
adding a display identifier to a live broadcast room corresponding to the speech signal of the set type condition; and
arranging and displaying the at least one live broadcast room in a display interface corresponding to the target classification label according to the display identifier.

2. The method of claim 1, wherein the set type condition comprises a singing condition.

3. The method of claim 2, wherein the speech detection model is obtained by training a set deep learning model using singing type speech signal samples and non-singing type speech signal samples.

4. The method of claim 2, before the inputting the speech signal within the set duration of the at least one live broadcast room into the speech detection model to obtain the speech signal that satisfies the set type condition, further comprising:
respectively obtaining singing type speech signal samples and non-singing type speech signal samples; and
training a set deep learning model using the singing type speech signal samples and the non-singing type speech signal samples to obtain the speech detection model.

5. The method of claim 4, wherein the respectively obtaining the singing type speech signal samples and the non-singing type speech signal samples comprises:
calling a search engine interface to search for and download a plurality of audio files matched with set keywords corresponding to the singing type and the non-singing type respectively;
randomly extracting a set number of audio files from a plurality of singing type audio files to configure as singing type speech signal samples; and
randomly extracting a set number of non-singing type audio files from a plurality of non-singing type audio files to configure as non-singing type speech signal samples.

6. The method of claim 2, wherein the arranging and displaying the at least one live broadcast room in the display interface corresponding to the target classification label according to the display identifier comprises:
acquiring a target live broadcast room with the display identifier added; and
topping the target live broadcast room in the display interface corresponding to the target classification label.

7. The method of claim 6, wherein the topping the target live broadcast room in the display interface corresponding to the target classification label comprises:
acquiring a current speech signal of the target live broadcast room in real time, and acquiring matched song content according to the current speech signal;
scoring the target live broadcast room according to a matching degree between the current speech signal and an audio feature of the song content; and
arranging the target broadcast room according to the score, and topping the arranged target broadcast room in the display interface corresponding to the target classification label.

8. The method of claim 7, after the acquiring the current speech signal of the target live broadcast room in real time, and acquiring the matched song content according to the current speech signal, further comprising:
displaying a song name corresponding to the song content in an information display area corresponding to the target live broadcast room in the display interface corresponding to the target classification label.

9. (canceled)

10. A computer device, comprising:
at least one processor; and
a memory, which is configured to store at least one program;
wherein when executed by the at least one processor, the at least one program enables the at least one processor to implement the live broadcast room display method of claim 1.

11. A computer-readable storage medium, which is configured to store a computer program, wherein when executed by a processor, the computer program implements the live broadcast room display method of claim 1.
